(19) United States
(12) Patent Application Publication
(10) Pub. No.: US 2025/0142690 A1
(43) Pub. Date: May 1, 2025

(54) MICROWAVE APPLIANCE WITH PROTECTED TEMPERATURE SENSOR

(71) Applicant: Haier US Appliance Solutions, Inc., Wilmington, DE (US)

(72) Inventors: Bagawathkumar Chellappan, Prospect, KY (US); Daryl C. Williams, Louisville, KY (US); Mark Heimerdinger, Louisville, KY (US)

(21) Appl. No.: 18/499,443

(22) Filed: Nov. 1, 2023

(51) Int. Cl. H05B 6/68; H05B 6/64

(52) U.S. Cl. CPC H05B 6/687; H05B 6/6455; H05B 6/6467

(57) ABSTRACT

A stand-alone temperature sensor is configured to connect wirelessly with a controller of a microwave appliance. The stand-alone temperature sensor includes a housing configured to shield one or more internal electronic components of the stand-alone temperature sensor from microwave radiation within the microwave appliance. The stand-alone temperature sensor includes an antenna extending from a casing of the stand-alone temperature sensor.

### FIELD OF THE INVENTION

The present subject matter relates generally to microwave appliances, and more particularly to sensors in microwave appliances.

### BACKGROUND OF THE INVENTION

Kitchen appliances, such as microwave appliances, can be used by consumers to perform tasks such as heating or cooking food. Generally, microwave appliances include a cabinet that defines a cooking chamber for receipt of food items for cooking. In order to provide selective access to the cooking chamber and to contain food items and cooking energy (e.g., microwaves) during a cooking operation, a door is further included that is typically pivotally mounted to the cabinet. During use, a magnetron can generate microwave radiation or microwaves that are directed specifically to the cooking chamber. The microwave radiation is typically able to heat and cook food items within the cooking chamber faster than would be possible with conventional cooking methods using direct or indirect heating methods. Moreover, since microwave appliances are often smaller than other appliances (e.g., a conventional baking oven) within a kitchen, microwave appliances are often preferable for heating relatively small portions or amounts of food.

However, achieving precise cooking or heating for liquid-based foods like coffee, tea, and water in typical microwave appliances is not possible. Accordingly, a microwave appliance capable of achieving precise cooking or heating for liquid-based foods would be advantageous in the art.

### BRIEF DESCRIPTION OF THE INVENTION

Aspects and advantages of the invention will be set forth in part in the following description, or may be obvious from the description, or may be learned through practice of the invention.

In one example aspect of the present disclosure is a method of operating a microwave appliance including a cabinet defining a cooking chamber, a heating assembly, and a controller. The method includes receiving, by the controller, a user input indicative of a heating operation of the microwave appliance, and performing, by the controller, the heating operation of the microwave appliance in response to the user input. The heating operation includes establishing, by the controller, a wireless connection with a stand-alone temperature sensor of the microwave appliance, receiving, at the controller, a temperature reading from the stand-alone temperature sensor disposed within the cooking chamber of the microwave appliance, and adjusting, by the controller, a power level of the heating assembly in response to the temperature reading from the stand-alone temperature sensor.

In another example aspect of the present disclosure, a stand-alone temperature sensor is configured to connect wirelessly with a controller of a microwave appliance. The stand-alone temperature sensor includes a housing configured to shield one or more internal electronic components of the stand-alone temperature sensor from microwave radiation within the microwave appliance.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a microwave appliance according to example embodiments of the present disclosure.

FIG. 2 provides a side schematic view of the example microwave of FIG. 1.

FIG. 3 provides a side perspective view of a stand-alone temperature sensor according to an example embodiment of the present disclosure.

FIG. 4 provides a side perspective view of a stand-alone temperature sensor according to another example embodiment of the present disclosure.

FIG. 5 provides a side perspective view of a stand-alone temperature sensor according to another example embodiment of the present disclosure.

FIG. 6 provides a flowchart of an example method of operating a microwave appliance according to example embodiments of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

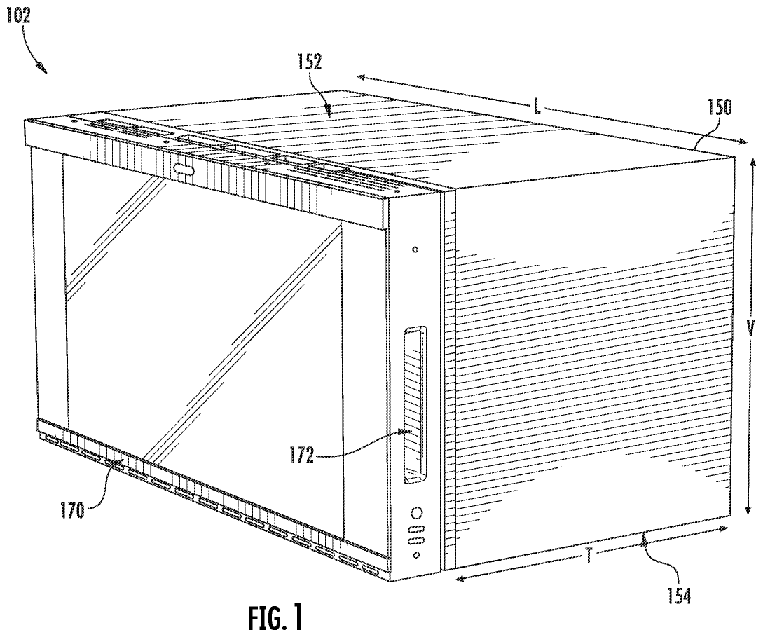

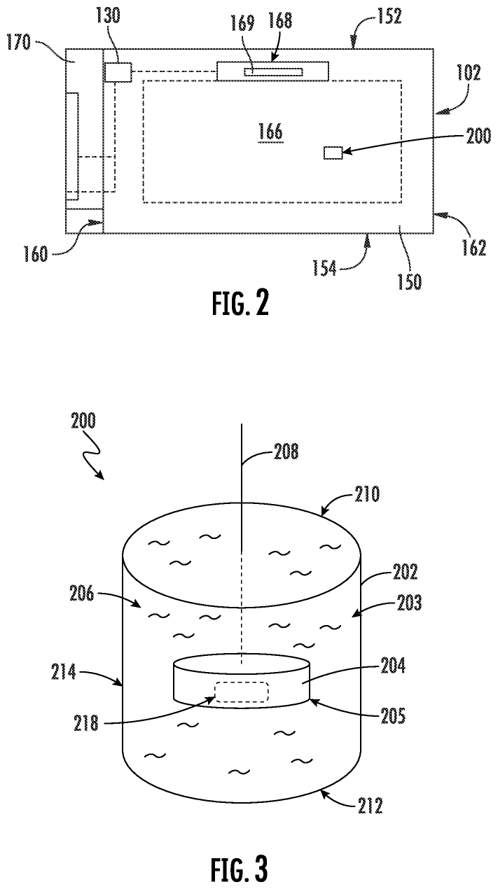

Turning to the figures, FIGS. 1 and 2 provide various views of a microwave appliance 102. Microwave appliance 102 is generally configured to heat articles (e.g., food or beverages) within a cooking chamber 166 using electromagnetic radiation. Microwave appliance 102 may include various components which operate to produce electromagnetic radiation, as is generally understood. For example, microwave appliance 102 may include a heating assembly 168 having a magnetron 169 (e.g., a cavity magnetron), a high voltage transformer (not shown), a high voltage capacitor (not shown), and a high voltage diode (not shown), as is understood. The transformer may provide energy from a suitable energy source (such as an electrical outlet) to the magnetron. The magnetron may convert the energy to electromagnetic radiation, specifically microwave radiation. The capacitor generally connects the magnetron and transformer, such as via high voltage diode, to a chassis. Microwave radiation produced by the magnetron may be transmitted through a waveguide to cooking chamber 166.

The structure and intended function of microwave ovens or appliances are generally understood by those of ordinary skill in the art and are not described in further detail herein. According to alternative embodiments, microwave appliance 102 may include one or more heating elements, such as electric resistance heating elements, gas burners, other microwave heating elements, halogen heating elements, or suitable combinations thereof, are positioned within cooking chamber 166 for heating cooking chamber 166 and food items positioned therein.

Microwave appliance 102 includes a cabinet 150. Cabinet 150 generally extends between a top end 152 and a bottom end 154 in the vertical direction V, and between a front end 160 and a rear end 162 in the transverse direction T. Cabinet 150 may also generally define cooking chamber 166. Microwave appliance 102 further includes a door assembly 170 that is movably mounted (e.g., rotatably attached) to cabinet 150 in order to permit selective access to cooking chamber 166. Specifically, door assembly 170 can move between an open position (not pictured) and a closed position (e.g., FIG. 1). The open position permits access to cooking chamber 166 while the closed position restricts access to cooking chamber 166. Except as otherwise indicated, with respect to the directions (e.g., the vertical direction V, the lateral direction L, and the transverse direction T), the door assembly 170 is described in the closed position. A handle 172 may be mounted to or formed on door assembly 170 to assist a user with opening and closing door assembly 170. As an example, a user can pull on handle 172 to open or close door assembly 170 and access or cover cooking chamber 166. Additionally, or alternatively, microwave appliance 102 may include a door release button (not pictured) that disengages or otherwise pushes open door assembly 170 when depressed.

Microwave appliance 102 may include a controller 130 that facilitates operation of microwave appliance 102. Controller 130 may be mounted within cabinet 150 or may be positioned and integrated in any other suitable manner.

In some embodiments, controller 130 includes one or more memory devices and one or more processors. The processors can be any combination of general or special purpose processors, CPUs, or the like that can execute programming instructions or control code associated with operation of microwave appliance 102. The memory devices (i.e., memory) may represent random access memory such as DRAM or read only memory such as ROM or FLASH. In one embodiment, the processor executes programming instructions stored in memory. The memory may be a separate component from the processor or may be included onboard within the processor. Alternatively, controller 130 may be constructed without using a processor, for example, using a combination of discrete analog or digital logic circuitry (such as switches, amplifiers, integrators, comparators, flip-flops, AND gates, and the like) to perform control functionality instead of relying upon software.

In certain embodiments, controller 130 includes a network interface such that controller 130 can connect to and communicate over one or more networks with one or more network nodes. Controller 130 can also include one or more transmitting, receiving, or transceiving components for transmitting/receiving communications with other devices communicatively coupled with microwave appliance 102. Additionally, or alternatively, one or more transmitting, receiving, or transceiving components can be located off board controller 130. Generally, controller 130 can be positioned in any suitable location throughout microwave appliance 102. For example, controller 130 may be located proximate door assembly 170 toward the front portion of microwave appliance 102.

As may be generally seen in FIG. 2, a sensor assembly, e.g., a stand-alone temperature sensor 200, may be positioned within cooking chamber 166. In general, stand-alone temperature sensor 200 may be configured to connect wirelessly with controller 130 of microwave appliance 102. For example, stand-alone temperature sensor 200 may be wirelessly connected to controller 130 of microwave appliance 102 over Bluetooth or any other suitable network. As will be explained hereinbelow, stand-alone temperature sensor 200 may advantageously be positioned within cooking chamber 166 of microwave appliance 102 in order to provide more precise cooking of food items within microwave appliance 102.

Referring now to FIGS. 3-5, provided is a side perspective view of stand-alone temperature sensor 200 according to example embodiments of the present disclosure. In general, stand-alone temperature sensor 200 includes a housing 202 with a temperature sensor 204 within housing 202. Housing 202 may generally extend between a top side 210 and a bottom side 212 in the vertical direction V, and a sidewall 214, extending circumferentially, such as a cylindrical shape as shown in FIG. 3, or in other example embodiments, a plurality of sidewalls may form any other suitable polygonal shape, such as a square. In general, housing 202 defines a pocket 203 within housing 202. Temperature sensor 204 may generally be within pocket 203 of housing 202.

In some example embodiments, temperature sensor 204 may be an optical temperature sensor. For example, temperature sensor 204 may be configured to detect infrared radiation emitting from a food item being cooked in cooking chamber 166 of microwave appliance 102. In another example embodiment, temperature sensor 204 may be an ultrasonic temperature sensor. For example, temperature sensor 204 may be configured to pulse sound waves off of a food item being cooked in a cavity of the microwave appliance and analyze a speed of returning sound waves. Furthermore, in other example embodiments, temperature sensor 204 may be a humidity sensor, odor sensor, or any other suitable sensor. Additionally, or alternatively, stand-alone temperature sensor 200 may connected with a battery pack or suitable powering device (not shown).

In general, temperature sensor 204 may include a casing 205 formed around one or more internal electronic components 218 of the stand-alone temperature sensor 200. Generally, extending from casing 205 of temperature sensor 204 and out from housing 202 of stand-alone temperature sensor 200 may be an antenna 208. Antenna 208 may be generally configured to transmit temperature readings, via the wireless connection, to controller 130 of microwave appliance 102.

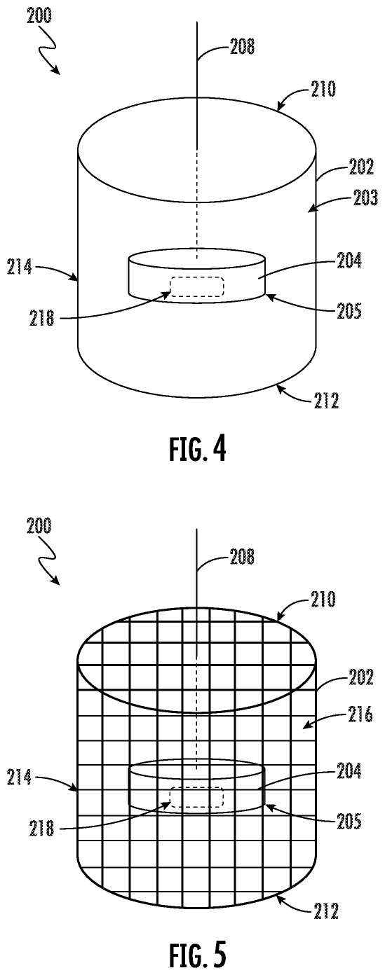

As mentioned above, stand-alone temperature sensor 200 may be positioned within cooking chamber 166. For example, stand-alone temperature sensor 200 may be placed within food items, e.g., within containers such as coffee mugs or the like, such as within about twenty millimeters (20 mm) from an outer wall of the container, to advantageously provide more precise cooking of food items. As such, housing 202 may be configured to shield the one or more internal electronic components 218 of stand-alone temperature sensor 200 from microwave radiation (e.g., emitting from magnetron 169) within cooking chamber 166 of microwave appliance 102. In general, each of FIGS. 3-5 provide example embodiments of a medium for shielding temperature sensor 204 from microwave radiation. For example, as may be seen in FIG. 3, housing 202 of stand-alone temperature sensor 200 may include a fluid 206, such as thermic fluid or glycol, within pocket 203 of housing 202, surrounding temperature sensor 204. In particular, fluid 206 within the housing may shield microwave radiation from the one or more internal electronic components 218 of stand-alone temperature sensor 200. Further, as may be seen in FIG. 4, housing 202 of stand-alone temperature sensor 200 may be a low permittivity casing, such as Polytetrafluoroethylene (PTFE). In particular, the low permittivity casing may absorb microwave radiation from the one or more internal electronic components 218 of stand-alone temperature sensor 200. Moreover, as may be seen in FIG. 5, housing 202 of stand-alone temperature sensor 200 may be a metal barrier, such as a Faraday cage or other suitable metallic structure. The metal barrier may reflect microwave radiation away from the one or more internal electronic components 218 of stand-alone temperature sensor 200. The metal barrier may include a plurality of openings 216, whereby temperature sensor 204 may be configured to take temperature readings through the plurality of openings 216.

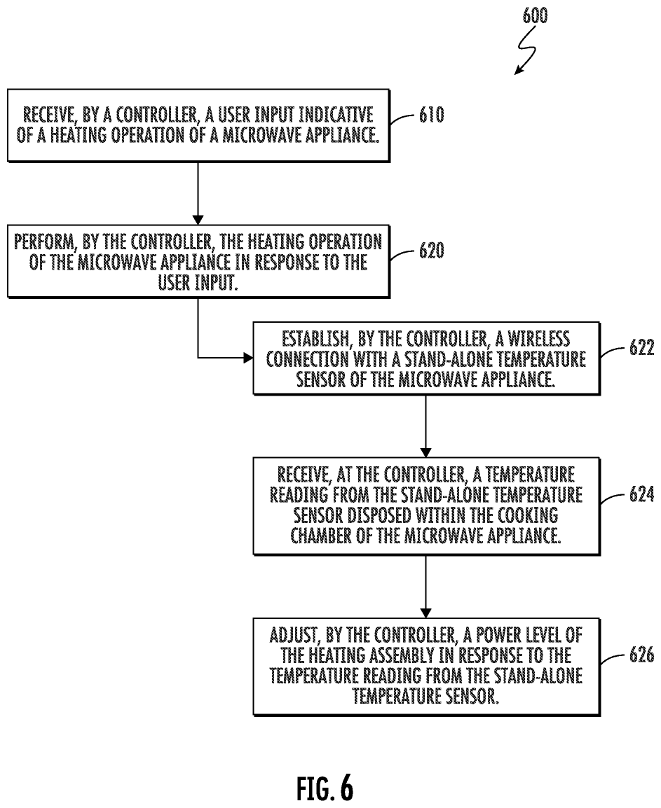

Now that the construction of microwave appliance 102 and the configuration of controller 130 according to example embodiments have been presented, an example method (e.g., method 600) of operating a microwave appliance will be described. Although the discussion below refers to the example method 600 of operating microwave appliance 102, one skilled in the art will appreciate that the example method 600 is applicable to the operation of a variety of other appliances, such as countertop or combination appliances. In example embodiments, the various method steps as disclosed herein may be performed (e.g., in whole or part) by controller 130, or another, separate, dedicated controller. FIG. 6 depicts steps performed in a particular order for the purpose of illustration and discussion. Moreover, the steps of method 600 may be modified, adapted, rearranged, omitted, interchanged, or expanded in various ways without deviating from the scope of the present disclosure.

Referring now to FIG. 6, at (610), method 600 may generally include receiving, by controller 130, a user input indicative of a heating operation of the microwave appliance 102. In general, the user input may be conducted over network connection to an external device or may be inputs on a user interface of the microwave appliance (not shown). The heating operation may indicate a temperature to which the user desires the food item to be heated. The heating operation will be further described hereinbelow.

At (620), method 600 may generally include performing, by controller 130, the heating operation of microwave appliance 102 in response to the user input. In particular, the heating operation may include, at (622), establishing, by controller 130, wireless connection with stand-alone temperature sensor 200 of microwave appliance 102, at (624), receiving, at controller 130, a temperature reading from stand-alone temperature sensor 200 disposed within cooking chamber 166 of microwave appliance 102, and at (626), adjusting, by controller 130, a power level of heating assembly 168 in response to the temperature reading from stand-alone temperature sensor 200. As such, with temperature readings feedback to controller 130 of microwave appliance 102, controller 130 may automatically determine the heating power level and heating sequence based on the specific food item temperature during the cooking process in order to cook food items more precisely to desired temperature levels.

As may be seen from the above, a wireless temperature sensor for microwave appliances may measure food item temperature and determine heating sequence/power level per food item and adjust the heat level (e.g., magnetron level) accordingly. The wireless temperature sensor may be used for detecting precise cooking or heating of liquid-based foods like coffee, tea, and water. When the sensor is placed inside the microwave it may be protected from potential damage caused by microwaves energy by a housing, such as a cylindrical enclosure that may be filled with liquid, thermic fluid, glycol, PTFE, or any other suitable low permittivity material, or in another example embodiment, a metal barrier, or a specially designed Faraday cage to protect the sensor from microwaves.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating a microwave appliance, the microwave appliance comprising a cabinet defining a cooking chamber, a heating assembly, and a controller, the method comprising:
receiving, by the controller, a user input indicative of a heating operation of the microwave appliance; and
performing, by the controller, the heating operation of the microwave appliance in response to the user input, the heating operation comprising:
establishing, by the controller, a wireless connection with a stand-alone temperature sensor of the microwave appliance;
receiving, at the controller, a temperature reading from the stand-alone temperature sensor disposed within the cooking chamber of the microwave appliance; and
adjusting, by the controller, a power level of the heating assembly in response to the temperature reading from the stand-alone temperature sensor.

2. The method of claim 1, wherein receiving the temperature reading from the stand-alone temperature sensor comprises transmitting the temperature reading from an antenna via the wireless connection, the antenna extending from a casing of the stand-alone temperature sensor.

3. The method of claim 2, wherein the heating assembly comprises a magnetron, the heating operation further comprises emitting microwaves from the magnetron into the cooking chamber during the heating operation.

4. The method of claim 3, wherein the stand-alone temperature sensor comprises one or more internal electronic components within the casing of the stand-alone temperature sensor, the stand-alone temperature sensor also comprising a low permittivity casing, wherein emitting microwaves from the magnetron into the cooking chamber during the heating operation comprises shielding, via the low permittivity casing, the one or more internal electronic components of the stand-alone temperature sensor from the microwaves emitting from the magnetron.

5. The method of claim 3, wherein the stand-alone temperature sensor comprises one or more internal electronic components within the casing of the stand-alone temperature sensor, the stand-alone temperature sensor also comprising a housing comprising a fluid within the housing surrounding the stand-alone temperature sensor, wherein emitting microwaves from the magnetron into the cooking chamber during the heating operation comprises shielding, via the fluid within the housing, one or more internal electronic components of the stand-alone temperature sensor from the microwaves emitting from the magnetron.

6. The method of claim 3, wherein the stand-alone temperature sensor comprises one or more internal electronic components within the casing of the stand-alone temperature sensor, the stand-alone temperature sensor also comprising a metal barrier, wherein emitting microwaves from the magnetron into the cooking chamber during the heating operation comprises shielding, via the metal barrier, the one or more internal electronic components of the stand-alone temperature sensor from the microwaves emitting from the magnetron.

7. The method of claim 6, wherein the metal barrier comprises a plurality of openings, whereby the stand-alone temperature sensor takes temperature readings through the plurality of openings.

8. The method of claim 1, wherein the stand-alone temperature sensor is an optical temperature sensor, wherein the temperature reading from the stand-alone temperature sensor comprises detecting infrared radiation emitting from a food item being cooked in the cooking chamber.

9. The method of claim 1, wherein the stand-alone temperature sensor is an ultrasonic temperature sensor, wherein the temperature reading from the stand-alone temperature sensor comprises pulsing sound waves off of a food item being cooked in the cooking chamber and analyzing a speed of returning sound waves.

10. A stand-alone temperature sensor configured to connect wirelessly with a controller of a microwave appliance, the stand-alone temperature sensor comprising a housing configured to shield one or more internal electronic components of the stand-alone temperature sensor from microwave radiation within the microwave appliance.

11. The stand-alone temperature sensor of claim 10, wherein the stand-alone temperature sensor comprises an antenna extending from a casing of the stand-alone temperature sensor, the antenna configured to transmit temperature readings, via the wireless connection, to the controller of the microwave appliance.

12. The stand-alone temperature sensor of claim 11, wherein the microwave appliance comprises a magnetron configured to emit microwave radiation from the magnetron into a cooking chamber of the microwave appliance.

13. The stand-alone temperature sensor of claim 12, wherein the stand-alone temperature sensor further comprises the one or more internal electronic components within the casing of the stand-alone temperature sensor, wherein the housing of the stand-alone temperature sensor is a low permittivity casing, and wherein the low permittivity casing shields the one or more internal electronic components of the stand-alone temperature sensor from microwave radiation within the microwave appliance.

14. The stand-alone temperature sensor of claim 12, wherein the stand-alone temperature sensor further comprises the one or more internal electronic components within the casing of the stand-alone temperature sensor, wherein the housing of the stand-alone temperature sensor comprises a fluid within the housing surrounding the stand-alone temperature sensor, wherein the fluid within the housing shields the one or more internal electronic components of the stand-alone temperature sensor from microwave radiation within the microwave appliance.

15. The stand-alone temperature sensor of claim 12, wherein the stand-alone temperature sensor further comprises the one or more internal electronic components within the casing of the stand-alone temperature sensor, wherein the housing of the stand-alone temperature sensor is a metal barrier, wherein the metal barrier shields the one or more internal electronic components of the stand-alone temperature sensor from microwave radiation within the microwave appliance.

16. The stand-alone temperature sensor of claim 15, wherein the metal barrier comprises a plurality of openings, whereby the stand-alone temperature sensor is configured to take temperature readings through the plurality of openings.

17. The stand-alone temperature sensor of claim 10, wherein the stand-alone temperature sensor is an optical temperature sensor, the stand-alone temperature sensor configured to detect infrared radiation emitting from a food item being cooked in a cooking chamber of the microwave appliance.

18. The stand-alone temperature sensor of claim 10, wherein the stand-alone temperature sensor is an ultrasonic temperature sensor, the stand-alone temperature sensor configured to pulse sound waves off of a food item being cooked in a cooking chamber of the microwave appliance and analyze a speed of returning sound waves.
